(19) United States
(12) Patent Application Publication
(10) Pub. No.: US 2014/0054824 A1
(43) Pub. Date: Feb. 27, 2014

(54) INSERT MOLDING METHOD AND ARTICLE FORMED BY SAME

(71) Applicants: HON HAI PRECISION INDUSTRY CO., LTD., New Taipei (TW); Fu Tai Hua Industry (Shenzhen) Co., Ltd., Shenzhen (CN)

(72) Inventor: ZHI-HUA LIU, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/955,224

(22) Filed: Jul. 31, 2013

(30) Foreign Application Priority Data
Aug. 23, 2012 (CN) 2012103016801

(51) Int. Cl. B29C 37/00

(52) U.S. Cl. CPC B29C 37/0003; B29C 37/0053
USPC 264/318; 428/131

(57) ABSTRACT

An insert molding method includes providing a mold and a pin, and predetermining a mold releasing direction of the mold. The pin includes a latching portion. A preform and a depressed portion of a mold releasing hole in the preform are formed via the mold and the pin. The depressed portion is formed at an end of the preform along the mold releasing direction. The pin passes through the depressed portion and is partly received in the preform. The pin is released to release the preform from the mold, and the latching portion resists and drags along inner surface in the mold releasing hole in the preform along the mold releasing direction. A plurality of burrs is produced and received in the depressed portion. The preform is cooled to form an article.

### BACKGROUND

1. Technical Field

The present disclosure relates to an insert molding method, and particularly to an insert molding method by which a mold is released easily and an article is formed by the insert molding method.

2. Description of Related Art

When an article is released from a mold in an insert molding method, the article may easily be stuck to the mold. Thus, a pin with a hooked end connected to or formed on the mold may be used to free or release the article from the mold. However, the hooked end may damage the article during release causing a flash or burr to form on the article, so a burr cutting or removing process needs to be implemented. Therefore, a cost for forming the article by the inserting molding method is high, and the article is formed at a low efficiency. In addition, even though the flash or burr is removed, a cutting mark remains on the article, which negatively affects an appearance of the article.

Therefore, there is room for improvement in the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is a flow chart of an embodiment of an insert molding method, wherein a releasing assembly is configured for releasing a preform to form an article.

FIG. 2 is an exploded, isometric view of the releasing assembly and the preform in FIG. 1.

FIG. 3 is an isometric view of the releasing assembly and the preform in FIG. 2.

FIG. 4 is a cross sectional view taken along line IV-IV in FIG. 3

FIG. 5 is a cross sectional view of the article in FIG. 2 assembled with a screw in a use state.

### DETAILED DESCRIPTION

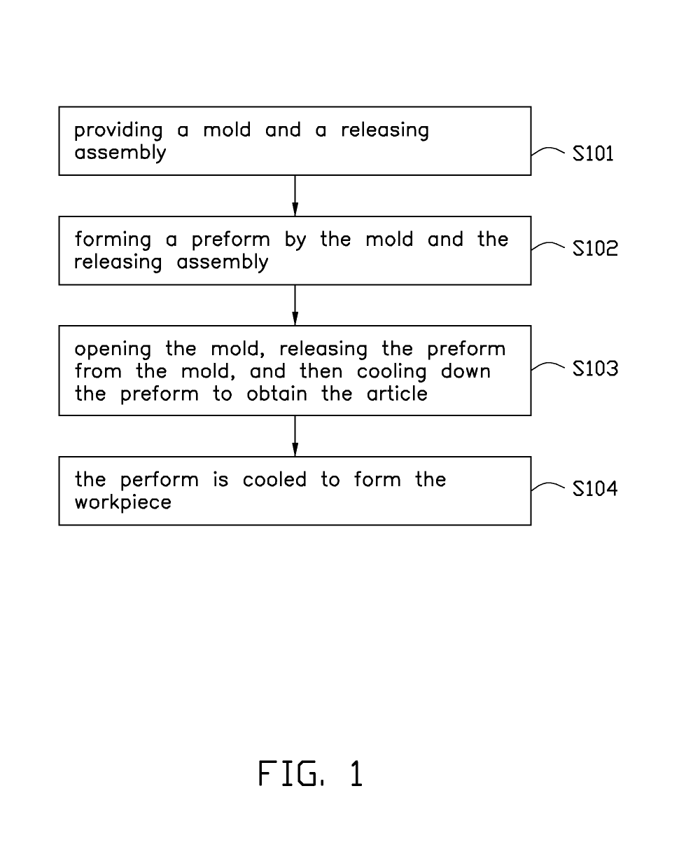

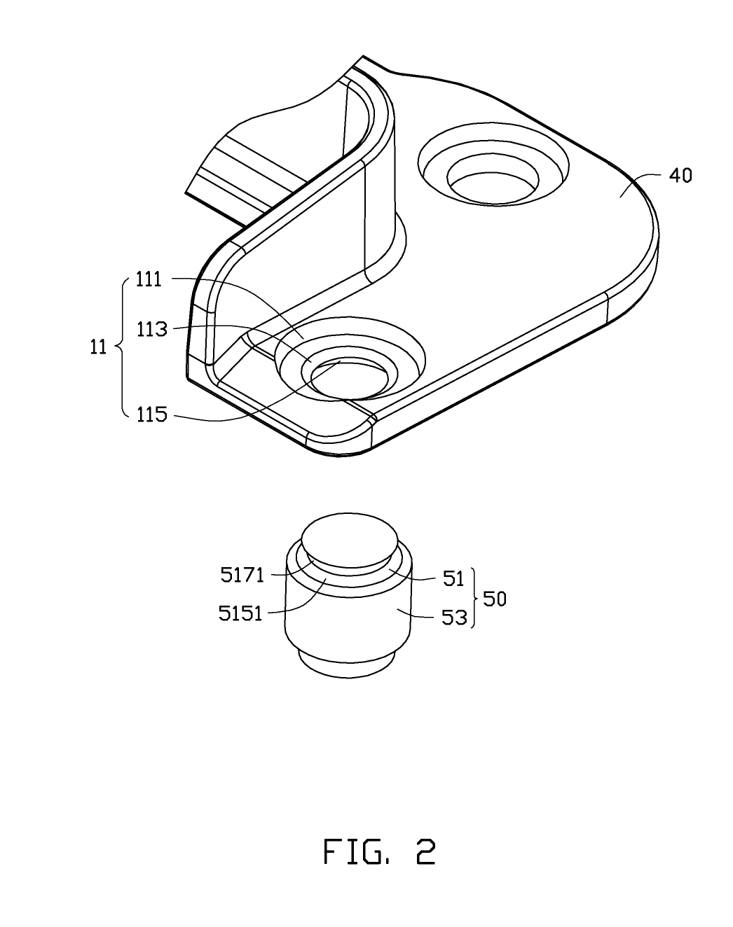

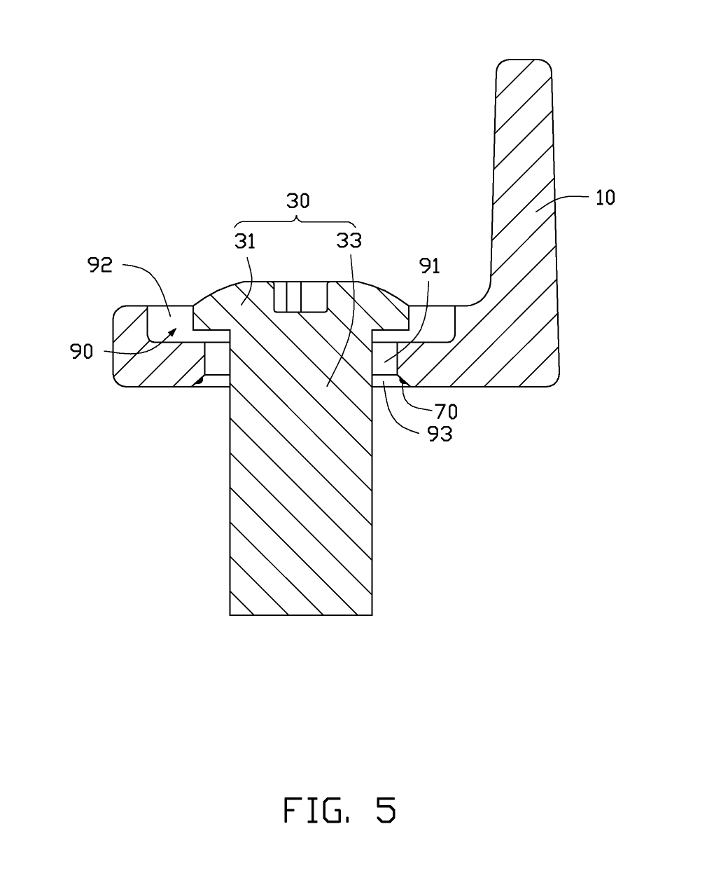

FIG. 1 shows a flow chart of one embodiment of an insert molding method for forming an article 10 (shown in FIG. 5). FIGS. 2 through 4 show a mold 20 and a releasing assembly 50, which are used in the inset molding method. The mold 20 includes a male mold 21 and a female mold 22. The male mold 21 defines a male cavity 211. The female mold 22 defines a female cavity 221. The male cavity 211 and the female cavity 221 cooperatively form a profile of the article 10. The releasing assembly 50 is mounted on the male mold 21, and includes a pin 51 and a sleeve 53 sleeved on the pin 51. The pin 51 includes a main body 511 and an end portion 513 formed on a distal end of the main body 511. The main body 511 is substantially cylindrical. The end portion 513 protrudes into the male cavity 211, and includes an engaging portion 515 and a latching portion 517 formed on a distal end of the engaging portion 515 away from the main body 511. The engaging portion 515 is a substantially conical frustum, and includes an engaging surface 5151 at an outer periphery thereof. The engaging surface 5151 is inwardly sloped along a direction from the engaging portion 515 to the latching portion 517. The latching portion 517 is a substantially conical frustum, and includes a latching surface 5171 at an outer periphery thereof. The latching surface 5171 is inwardly sloped along a direction from the latching portion 517 to the engaging portion 515. The sleeve 53 is sleeved on the main body 511 of the pin 51. The insert molding method for forming the article 10 employing the mold 20 and the releasing assembly 50 is illustrated as follows.

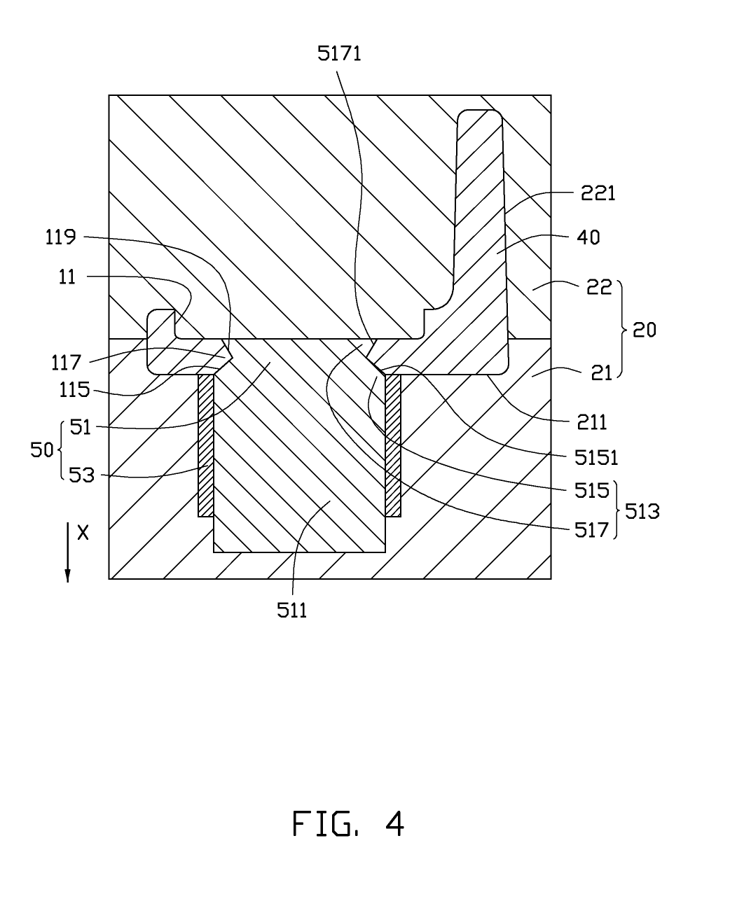

In Step S101, a mold 20 and a releasing assembly 50 are provided. A mold releasing direction X of the mold 20 is predetermined The mold releasing direction X is parallel to an axial direction of the releasing assembly 50 (shown in FIG. 4).

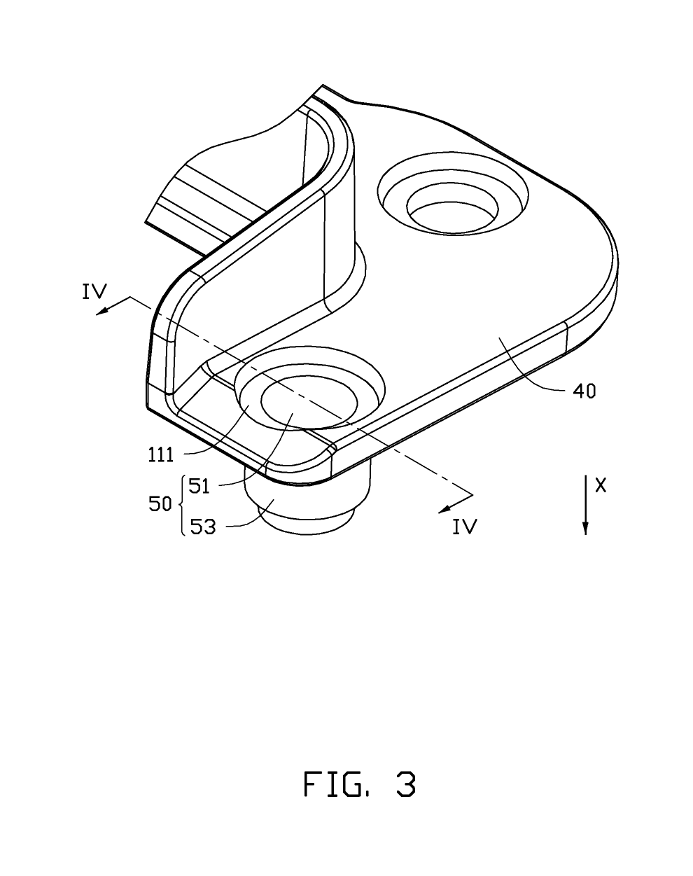

In Step S102, a preform 40 (partly shown in FIGS. 2-3) is formed by the mold 20 and the releasing assembly 50. A mold releasing hole 11 is defined in the preform 40 along the mold releasing direction X. The preform 40 is received in the male cavity 211 and the female cavity 221. An axial direction of the mold releasing hole 11 and the releasing assembly 50 is parallel to the mold releasing direction X. The releasing assembly 50 is mounted over the mold releasing hole 11.

The releasing assembly 50 is positioned at a side of the preform 40. The mold releasing hole 11 is a substantially stepped hole, and includes a containing portion 111, a receiving portion 113 communicating with the containing portion 111, and a depressed portion 115 communicating with the receiving portion 113. The containing portion 111 is substantially cylindrical. The receiving portion 113 is substantially frustum-shaped. A diameter of the containing portion 111 is greater than a diameter of the receiving portion 113. The receiving portion 113 is formed corresponding to the latching portion 517 of the pin 51, and includes a resisting surface 119 corresponding to the latching surface 5171 of the latching portion 517. The resisting surface 119 is inwardly sloped downward along the mold releasing direction X. The depressed portion 115 of the mold releasing hole 11 is formed corresponding to the engaging portion 515 of the pin 51. A shape of the depressed portion 115 matches with a shape of the engaging portion 515. A sidewall of the depressed portion 115 is sloped downward and away from the axis of the mold releasing hole 11. A maximum diameter of the depressed portion 115 is greater than a maximum diameter of the receiving portion 113, and a space formed in the depressed portion 115 is greater than a space formed in the receiving portion 113. Because the receiving portion 113 and the depressed portion 115 correspond to the latching portion 517 and the engaging portion 515, respectively, a protruding portion 117 of the preform 40 is formed at a connecting portion of the depressed portion 115 and the receiving portion 113 of the mold releasing hole 11.

In Step S103, the mold 20 is opened, and the preform 40 is released from the mold 20 after releasing the releasing assembly 50; and then the preform 40 is cooled down to obtain the article 10. The latching portion 517 resists and drags along the resisting surface 119, so that a force is exerted on the resisting surface 119 during the release of the pin 51. Thus, the protruding portion 117 of the preform 40 is deformed by the latching surface 5171 (of the pin 51) following the release of the pin 51, thus defining a forming hole 90 in the article 10 corresponding to the mold releasing hole 11 in the preform 40 and forming a plurality of burrs 70 (shown in FIG. 5) in the space corresponding to the depressed portion 115 of the mold releasing hole 11. The receiving portion 113 of the mold releasing hole 11 is deformed to form a cylindrical portion 91 of the forming hole 90. The containing portion 111 is formed to be a screw head containing portion 92 of the forming hole 90. The depressed portion 115 is formed to be a concaving portion 93 of the forming hole 90. The burrs 70 are cooled in the concaving portion 93. In the illustrated embodiment, when the article 10 is assembled with other articles (not shown) by a screw 30, a screw head 31 of the screw 30 is received in the screw head containing portion 92, and a screw post 33 of the screw 30 is received in the cylindrical portion 91 of the article 10. Because the burrs 70 are received in the concaving portion 93, the burrs 70 do not affect the assembling of the screw 30 and the article 10. An assembling accuracy of the screw 30 and the article 10 and an appearance of the article 10 are not negatively affected by the presence of the burrs 70.

In an alternative embodiment, the sleeve 53 may be omitted, such that the preform 40 is formed via the mold 20 and the pin 51. The forming hole 90 may be used for other functions, such as for decoration, so that the screw head containing portion 92 may be omitted. The latching portion 517 may be other shapes, such as hook-shaped, cylindrical, conical, or serrated, for example. In an alternative embodiment, the depressed portion 115 may be formed by a mold having a protrusion, thus omitting the engaging portion 515 of the pin 51.

It is believed that the present embodiments and their advantages will be understood from the foregoing description, and it will be apparent that various changes may be made thereto without departing from the spirit and scope of the embodiments or sacrificing all of its material advantages.

What is claimed is:

1. An insert molding method, comprising following steps:
providing a mold and a pin mounted on the mold, a mold releasing direction of the mold being predetermined, the pin comprising a latching portion and an engaging portion, the latching portion formed at an end of the engaging portion along the mold releasing direction;
forming a preform by the mold and the pin, a mold releasing hole defined in the preform, an inner wall of the molding releasing hole comprising a receiving portion and a depressed portion at an end of the receiving portion along the mold releasing direction, the receiving portion formed corresponding to the latching portion, the depressed portion formed corresponding to the engaging portion;
opening the mold, releasing the preform from the mold, and cooling down the preform to obtain an article, pulling the preform along the mold releasing direction using the pin, resisting and dragging the inner surface of the mold releasing hole along the mold releasing direction by the latching portion, producing a plurality of burrs received in the depressed portion.

2. The insert molding method of claim 1, wherein the engaging portion comprises an engaging surface, the engaging surface is inwardly sloped along a direction from the engaging portion to the latching portion.

3. The insert molding method of claim 2, wherein the engaging portion is substantially a conical frustum.

4. The insert molding method of claim 1, wherein the mold comprises a male mold and a female mole, the male mold defines a male cavity, the pin is mounted on the male mold, the engaging portion and the latching portion protrude into the male cavity.

5. The insert molding method of claim 4, wherein the latching portion comprises a latching surface, and the receiving portion comprises a resisting surface corresponding to the latching surface, the resisting surface resists with the latching surface before the mold is opened, each of the resisting surface and the latching surface is inwardly sloped along a direction from the latching portion to the engaging portion.

6. The insert molding method of claim 5, wherein the mold releasing hole is formed to become a forming hole after the preform is cooled, the receiving portion of the mold releasing hole is deformed to form a cylindrical portion after the preform is cooled.

7. The insert molding method of claim 6, wherein the depressed portion is formed to become a concaving portion after the preform being cooled, the plurality of burrs are received in the concaving portion.

8. The insert molding method of claim 7, wherein the forming hole further comprises a screw head containing portion communicating with the cylindrical portion, and is configured to engage with a screw, a screw head of the screw is received in the screw head containing portion, a screw post of the screw is received in the cylindrical portion of the forming hole.

9. An article formed by an insert molding method, defining a forming hole, the forming hole comprising a cylindrical portion and a concaving portion communicating with the cylindrical portion, a plurality of burrs formed by the insert molding mold are received in the concaving portion.

10. An insert molding method, comprising following steps:
forming a preform by a mold and a pin mounted on the mold, a mold releasing direction being predetermined, the pin comprising a latching portion, a mold releasing hole being defined in the preform, and latched with the latching portion of the pin, the mold releasing hole defining a depressed portion at a distal end thereof along the mold releasing direction;
opening the mold, releasing the preform from the mold to obtain an article, pulling the preform along the mold releasing direction by the pin, resisting and dragging an inner surface of the mold releasing hole by the latching portion along the mold releasing direction, and then producing a plurality of burrs received in the depressed portion.

11. The insert molding method of claim 10, wherein the pin further comprises a main body and an engaging portion, the engaging portion interconnects the latching portion and the main body, the engaging portion comprises an engaging surface, the engaging surface is inwardly sloped along a direction from the engaging portion to the latching portion.

12. The insert molding method of claim 11, wherein the engaging portion is substantially a conical frustum.

13. The insert molding method of claim 10, wherein the mold comprises a male mold and a female mole, the male mold defines a male cavity, the pin is mounted on the male mold, the engaging portion and the latching portion protrude into the male cavity.

14. The insert molding method of claim 10, wherein the latching portion comprises a latching surface, the inner sidewall of the mold releasing hole comprises a receiving portion formed corresponding to the latching portion of the pin, the receiving portion comprises a resisting surface corresponding to the latching surface, the resisting surface resists with the latching surface before the mold being opened, each of the resisting surface and the latching surface is inwardly sloped along a direction from the latching portion to the engaging portion.

15. The insert molding method of claim 14, wherein a maximum diameter of the depressed portion is greater than a maximum diameter of the receiving portion.

16. The insert molding method of claim 15, wherein a space formed in the depressed portion is greater than a space formed in the receiving portion.
